(19) United States
(12) Patent Application Publication
(10) Pub. No.: US 2012/0068481 A1
(43) Pub. Date: Mar. 22, 2012

(54) SECURITY SEAL FOR LATCH AND HASP CLOSURE

(76) Inventors: Ralph J. MALLOZZI, Stony Point, NY (US); Robert C. BENNETT, Edina, MN (US)

(21) Appl. No.: 13/211,173

(22) Filed: Aug. 16, 2011

Related U.S. Application Data
(63) Continuation of application No. 12/153,367, filed on May 16, 2008, now abandoned.
(60) Provisional application No. 60/924,470, filed on May 16, 2007.

(51) Int. Cl. E05B 39/02

(52) U.S. Cl. 292/282

(57) ABSTRACT

A security seal for a latch and hasp closure or a similar closure including a flexible, elongated strap seal having an elongated opening therein for receiving a hasp. The seal further includes a locking post and a corresponding socket provided with one or more locking means for engaging the locking post so that the locking post cannot be removed without damaging the seal. The seal is also provided with an identification flag that is in a fixed positioned relative to the opening of the strap so that information displayed on the flag can be easily read or scanned without having to manipulate the seal.

### CROSS-REFERENCE TO RELATED APPLICATIONS

This application is a non-provisional application based on U.S. provisional application no. 60/924,470, which was filed on May 16, 2007, entitled “Security Seal for a Latch and Hasp Closure,” and the subject matter of which is hereby incorporated by reference in its entirety.

### FIELD OF THE INVENTION

The present invention is generally directed to a security seal for securing a latch and hasp closure or a similar closure. More specifically, the present invention is directed to such a security seal that does not permit opening of the seal without destroying or removing the seal.

### BACKGROUND OF THE INVENTION

A latch and hasp closure typically includes a latch or staple that extends through an opening in a hasp or strap. An auxiliary seal, such as padlock or shackle seal, is attached to the latch after the hasp is placed over the latch to seal the closure. The seal prohibits the opening in the hasp from being pulled over the latch and thus prevents the closure from being opened.

A latch and hasp closure is currently used to close doors and a variety of containers, such as mail bags, storage trunks, tool boxes, chests, cargo containers, doors, and lock boxes. Conventional latch and hasp closure seals often include information relevant to a container or the contents therein, such as identification markings, bar codes, shipping information, ownership information, and dates. This information is often displayed on a label or tag affixed to the seal.

However, the use of a label affixed to a latch and hasp closure seal to display pertinent information is often problematic. For example, it is often difficult to adhere labels to seals made of plastic material, such as polypropylene and polyethylene. Further, a label can be easily removed or covered with another label so that the correct information is no longer visible.

In addition, the use of a tag attached to a seal to display information is likewise inefficient. Conventional tags often move, rotate, or flip upside-down relative to the seal. Thus, it is difficult to maintain a tag in a position so that the information thereon can be easily and quickly read or scanned.

Thus, there exists a need for a security seal for a latch and hasp closure that not only indicates if the seal or hasp has been opened or tampered with but also includes an integral tag that allows information displayed thereon to be easily read or scanned.

### SUMMARY OF THE INVENTION

The present invention is directed to a security seal for a latch and hasp or similar closure that does not permit opening of the seal without destroying the seal. In addition to providing evidence of tampering, the security seal of the present invention also includes an integral tag that allows information displayed thereon to be easily read or scanned.

The security seal includes a flexible, elongated strap having an elongated opening therein for receiving a latch of a latch and haps closure. The seal further includes a locking post and a corresponding socket provided with locking means for engaging the locking post so that the locking post cannot be removed without damaging the seal. The seal also includes an identification flag that is in a fixed positioned relative to the opening of the strap so that information displayed the flag can be easily read or scanned without having to manipulate the closure seal.

### BRIEF DESCRIPTION OF THE DRAWINGS

A better understanding of the invention will be had with reference to the attached drawings wherein:

FIG. 1 is a perspective view of a conventional latch and hasp closure being used with a mail bag;

FIG. 2 is a perspective view of a security seal for a latch and hasp closure according to a first embodiment of the present invention;

FIG. 3 is a front elevation view of the security seal of FIG. 2;

FIG. 4 is a bottom plan view of the security seal of FIG. 2;

FIG. 5 is a rear elevation view of the security seal of FIG. 2;

FIG. 6 is a side view of the security seal of FIG. 2;

FIG. 7 is a perspective view of a security seal for a latch and hasp closure according to an alternative embodiment of the present invention;

FIG. 8 is a front elevation view of the security seal of FIG. 7;

FIG. 9 is a bottom plan view of the security seal of FIG. 7;

FIG. 10 is a rear elevation view of the security seal of FIG. 7;

FIG. 11 is a side view of the security seal of FIG. 7;

FIG. 12 is a perspective view of a security seal for a latch and hasp closure according to another embodiment of the present invention;

FIG. 13 is a front elevation view of the security seal of FIG. 12;

FIG. 14 is a bottom plan view of the security seal of FIG. 12;

FIG. 15 is a rear elevation view of the security seal of FIG. 12; and

FIG. 16 is a side view of the security seal of FIG. 12.

### DETAILED DESCRIPTION OF THE PREFERRED EMBODIMENTS

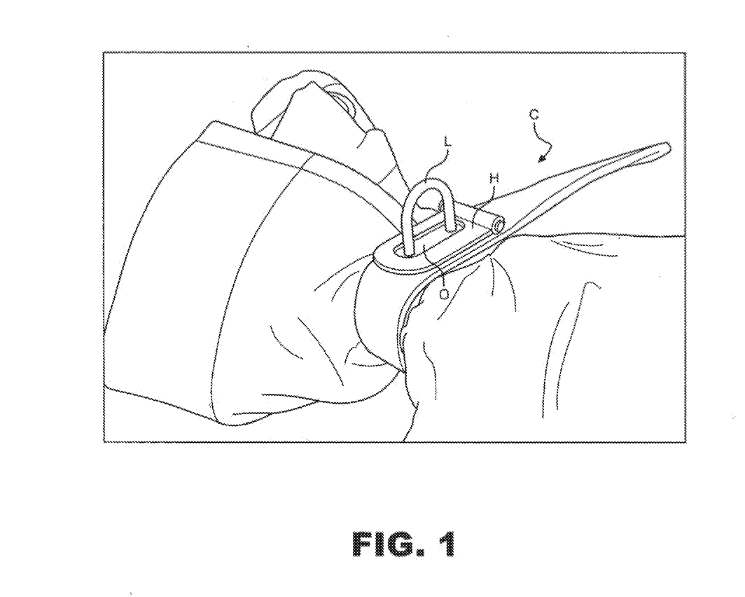

A conventional latch and hasp closure C is shown in FIG. 1. The latch and hasp closure C includes a latch L extending through an opening O in a hasp H. To seal a door or a container, such as a mail bag shown in FIG. 1, the opening O in the hasp H is placed over the latch L so that the latch L protrudes through the opening O.

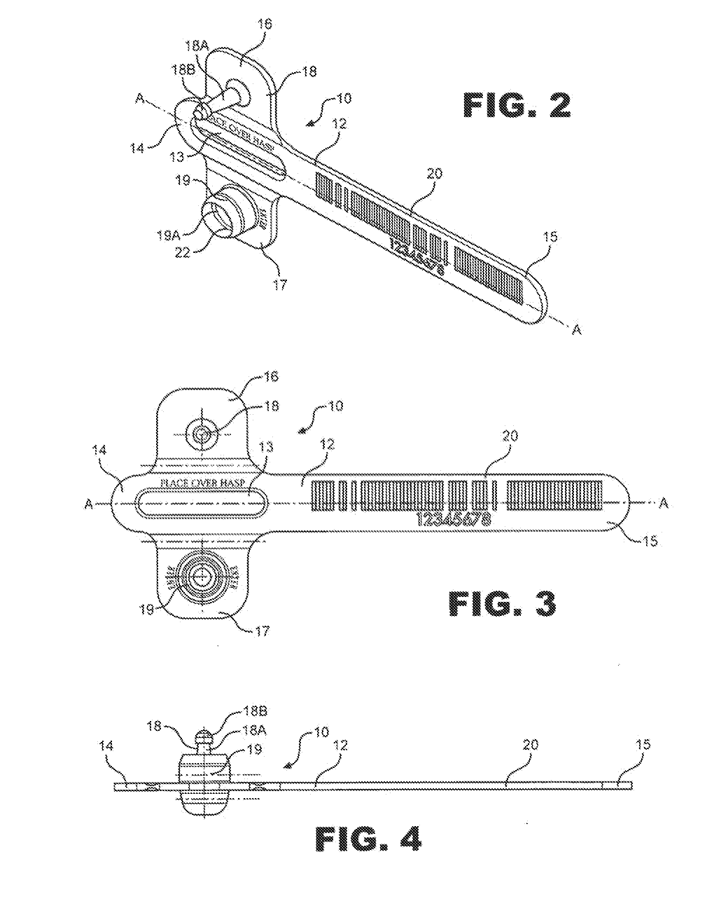

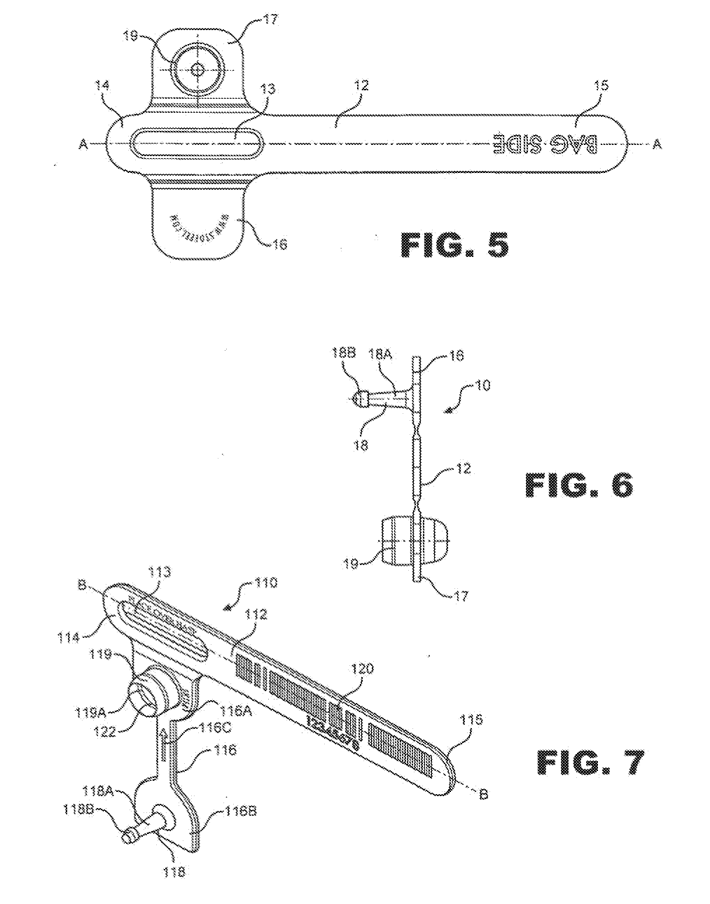

In a first embodiment shown in FIGS. 2-6, a security seal 10 for a latch and hasp closure or a similar closure comprises a flexible elongated seal strap 12 provided with an opening 13 for receiving a latch or similar structure. The opening 13 extends along a longitudinal axis A-A of the strap 12. The strap 12 also includes a first end 14 and a second end 15. At the first end 14 of the strap 12, a first tab 16 extends perpendicularly from the longitudinal axis A-A of the strap 12 and a second tab 17 extends perpendicularly from the longitudinal axis A-A of the strap 12 in an opposite direction from the first tab 16.

The first tab 16 is provided with a locking post 18 that protrudes perpendicularly from both the first tab 16 and the seal strap 12. Accordingly, the locking post 18 is in a different plane than the strap 12. The locking post 18 has an elongated body portion 18a and a head portion 18b having a diameter that is larger than a diameter of the body portion 18a.

The second tab 17 includes a socket 19 for receiving the locking post 18. The socket includes a central opening 19A and locking means for engaging the locking post 18 so that the locking post cannot be removed from the socket 19 without damaging the seal 10. The locking means includes an elastically deformable annular member 22 positioned within the socket 19. When the locking post 18 is inserted into the socket 19, the head portion 18b of the locking post 18 passes through the central opening 19A and deflects the annular member 22 inwardly to receive the locking post 18. When the locking post 18 is engaged in the socket 19, the annular member 22 engages the body portion 18a of the locking post 18 so that the annular member 22 cannot deflect outwardly to release the locking post 18. As a result, the locking post 18 cannot be removed from the socket 19 without damaging the seal 10.

Alternatively, the locking means for engaging the locking post 18 includes a plurality of elastically deformable tabs or teeth which function similarly to the annular member 22. Specifically, the tabs or teeth flex to permit the head portion 18b of the locking post 18 to pass therebetween. The teeth then return to their original positions to engage the body portion 18a of the locking tab and prevent the release of the locking post 18.

The second end 15 of the seal strap 12 includes an identification flag 20 which includes information, such as product information, dates, shipping information, instructions, bar codes, and the like. The identification flag 20 longitudinally extends in the same plane as the seal strap 12 and the opening 13. As a result, when the opening 13 is placed over a latch of a closure, the identification flag 20 is always positioned so that the information displayed thereon faces outwardly from the closure.

In a preferred embodiment, the seal 10 is formed of a single piece of injection molded plastic. Alternatively, the parts of the seal 10, including the strap 12, the first tab 16, the second tab 17, and the identification flag 20 can be made from any suitable material, such as plastics, rubbers, metals, leather, elastic, and any combination thereof.

To use the security seal 10 to seal a latch and hasp or similar closure, the opening 13 of the seal strap 12 is placed over the latch of the closure so that the locking post 18 projects outwardly from the closure. Since the opening 13 is longitudinal and extends along the longitudinal axis of the strap 12, the seal 10 does not rotate relative to the closure. Further, when the seal 10 is placed over the latch so that the locking post 18 projects outwardly from the closure, the information displayed on the identification flag 20 also faces outwardly from the closure. As a result, the information on the identification flag is maintained in a fixed position relative to the closure so that the information can be easily read or scanned without manipulation of the seal 10.

Once the latch of the closure is received in the opening 13 of the strap 12, the first tab 16 and the second tab 17 are bent toward the latch until the locking post 18 of the first tab 16 is positioned between the latch and the opening 13. The locking post 18 is then inserted into the socket 19 on the second tab 17, where the locking means for engaging the locking post 18 inside the socket 19 prevent the locking post 18 from being removed from the socket 19 without damaging the seal 10.

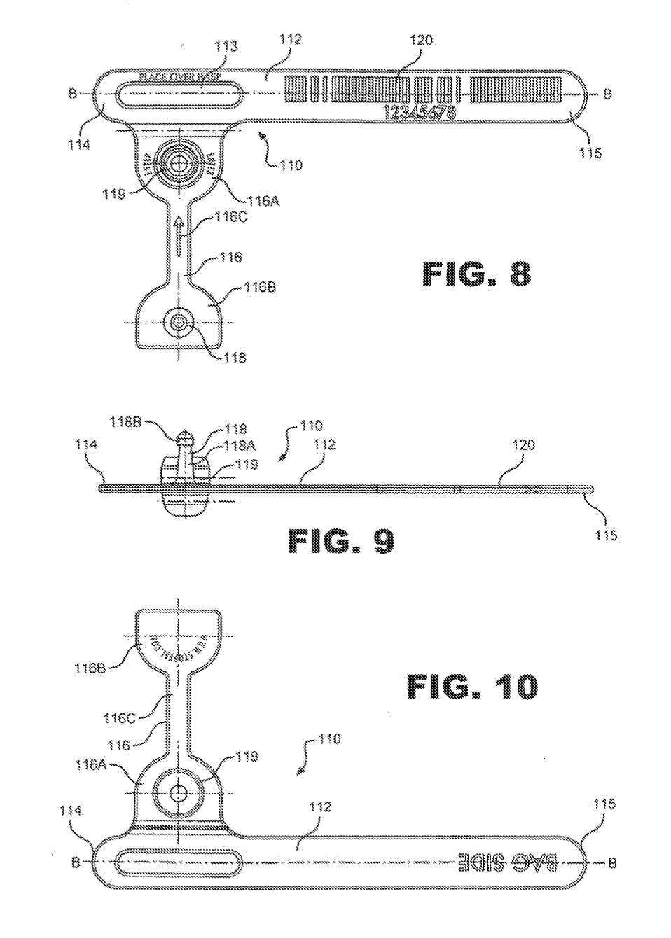

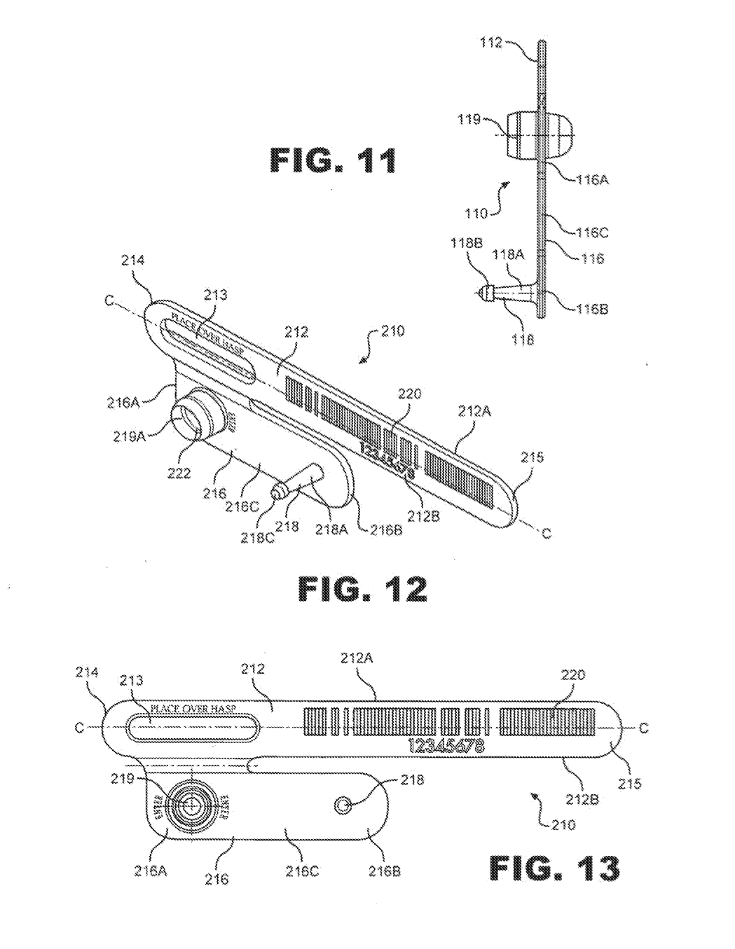

An alternative embodiment of the seal of the present invention is shown in FIGS. 7-11. A security seal 110 for a latch and hasp closure or a similar closure comprises a flexible elongated seal strap 112 provided with an opening 113 for receiving a latch or similar structure. The opening 113 extends along a longitudinal axis B-B of the strap 112. The strap 112 also includes a first end 114 and a second end 115.

At the first end 114 of the strap 112, a tab 116 extends perpendicularly from the longitudinal axis B-B of the strap 112. The tab 116 includes an upper end 116a, which is connected to the strap 112, and a lower end 116b. Preferably, the upper end 116a and the lower end 116b are connected by a thinner middle portion 116c.

The lower end 116b of the tab 116 is provided with a locking post 118 that protrudes perpendicularly from both the tab 116 and the seal strap 112. Accordingly, the locking post 118 is in a different plane than the strap 112. Similarly to the locking post 18 of the first embodiment, the locking post 118 has an elongated body portion 118a and a head portion 118b having a diameter that is larger than a diameter of the body portion 118a.

The upper end 116a of the tab 116 includes a socket 119 for receiving the locking post 118. Like the socket 19 of the preferred embodiment, the socket 119 includes a central opening 119A and locking means for engaging the locking post 118 so that the locking post cannot be removed from the socket 119 without damaging the seal 110. The locking means includes an elastically deformable annular member 122 or a plurality of elastically deformable tabs or teeth positioned within the socket 119.

The second end 115 of the seal strap 112 includes an identification flag 120 which includes information, such as product information, dates, shipping information, instructions, bar codes, and the like. The identification flag 120 longitudinally extends in the same plane as the seal strap 112 and the opening 113. As a result, when the opening 113 is placed over a latch of a closure, the identification flag 120 is always positioned so that the information displayed thereon faces outwardly from the closure.

Like seal 10, the seal 110 is preferably formed of a single piece of injection molded plastic. Alternatively, the parts of the seal 110, including the strap 112, the tab 116, and the identification flag 120 can be made from any suitable material, such as plastics, rubbers, metals, leather, elastic, and any combination thereof.

To use the security seal 110 to seal a latch and hasp or similar closure, the opening 113 of the seal strap 112 is placed over the latch of the closure so that the locking post 118 projects outwardly from the closure. Since the opening 113 is longitudinal and extends along the longitudinal axis B-B of the strap 112, the seal 110 does not rotate relative to the closure. Further, when the seal 110 is placed over the latch so that the locking post 118 projects outwardly from the closure, the information displayed on the identification flag 120 also faces outwardly from the closure. As a result, the information on the identification flag is maintained in a fixed position relative to the closure so that the information can be easily read or scanned without manipulation of the seal 110.

Once the latch of the closure is received in the opening 113 of the strap 112, the tab 116 is bent upwardly toward the latch until the tab 116 is approximately 90° from its original position. The middle portion 116c is then further bent upwardly toward the latch until the locking post 118 passes between the latch and the opening 113 toward the socket 119 on the upper end 116a of the tab 116. The locking post 118 is then inserted into the socket 119, where the locking means for engaging the locking post 118 inside the socket 119 prevent the locking post 118 from being removed from the socket 119 without damaging the seal 110.

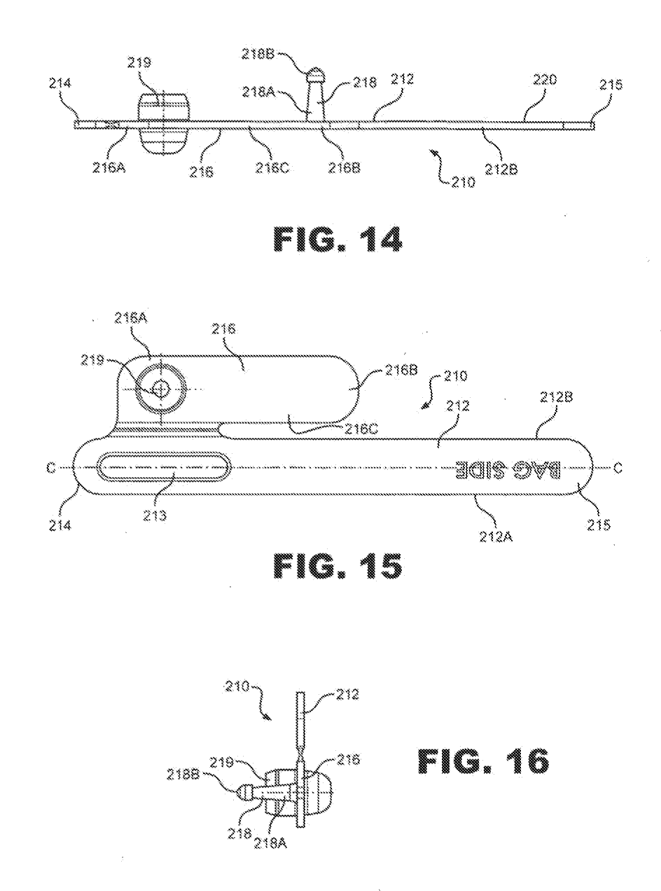

A third embodiment of the seal of the present invention is shown in FIGS. 12-16. A security seal 210 for a latch and hasp closure or a similar closure comprises a flexible elongated seal strap 212 provided with an opening 213 for receiving a latch or similar structure. The opening 213 extends along a longitudinal axis C-C of the strap 212. The strap 212 also includes an upper surface 212a, a lower surface 212b, a first end 214, and a second end 215.

At the first end 214 of the strap 212, a tab 216 is attached to the lower surface 212b of the strap 212. A longitudinal axis of the tab 216 is generally parallel to the longitudinal axis C-C of the strap 212. The tab 216 includes a first end 216a, which is connected to the strap 212, and a second end 216b. Preferably, the upper end 216a and the lower end 216b are connected by a middle portion 216c.

The second end 216b of the tab 216 is provided with a locking post 218 that protrudes perpendicularly from both the tab 216 and the seal strap 212. Accordingly, the locking post 218 is in a different plane than the strap 212. Similarly to the locking post 18 of the preferred embodiment, the locking post 218 has an elongated body portion 218a and a head portion 218b having a diameter that is larger than a diameter of the body portion 218a.

The first end 216a of the tab 216 includes a socket 219 for receiving the locking post 218. Like the socket 19 of the preferred embodiment, the socket 219 includes a central opening 219A and locking means for engaging the locking post 218 so that the locking post cannot be removed from the socket 219 without damaging the seal 210. The locking means includes an elastically deformable annular member 222 or a plurality of elastically deformable tabs or teeth positioned within the socket 219.

The second end 215 of the seal strap 212 includes an identification flag 220 which includes information, such as product information, dates, shipping information, instructions, bar codes, and the like. The identification flag 220 longitudinally extends in the same plane as the seal strap 212, the opening 213, and the tab 216. As a result, when the opening 213 is placed over a latch of a closure, the identification flag 220 is always positioned so that the information displayed thereon faces outwardly from the closure.

Like seal 10, the seal 210 is preferably formed of a single piece of injection molded plastic. Alternatively, the parts of the seal 210, including the strap 212, the tab 216, and the identification flag 220 can be made from any suitable material, such as plastics, rubbers, metals, leather, elastic, and any combination thereof.

To use the security seal 210 to seal a latch and hasp or similar closure, the opening 213 of the seal strap 212 is placed over the latch of the closure so that the locking post 218 projects outwardly from the closure. Since the opening 213 is longitudinal and extends along the longitudinal axis C-C of the strap 212, the seal 210 does not rotate relative to the closure. Further, when the seal 210 is placed over the latch so that the locking post 218 projects outwardly from the closure, the information displayed on the identification flag 220 also faces outwardly from the closure. As a result, the information on the identification flag is maintained in a fixed position relative to the closure so that the information can be easily read or scanned without manipulation of the seal 210.

Once the latch of the closure is received in the opening 213 of the strap 212, the tab 216 is bent upwardly toward the latch until the tab 216 is approximately 90° from its original position. The middle portion 216c of the tab 216 is then bent toward the latch until the locking post 218 passes between the latch and the opening 213 toward the socket 219 on the first end 216a of the tab 216. The locking post 218 is then inserted into the socket 219, where the locking means for engaging the locking post 218 inside the socket 219 prevent the locking post 218 from being removed from the socket 219 without damaging the seal 210.

The foregoing description of the present invention has been presented to illustrate the principles of the invention and not to limit the invention to the particular embodiments illustrated. It is intended that the scope of the invention be defined by all of the embodiments encompassed within the following claims and their equivalents.

We claim:

1. A security seal for a closure, comprising: a strap including a first end, a second end, and an opening disposed between said first end and said second end for attaching the seal to the closure, said first end having a post and a socket, said socket including a socket opening for receiving said post and a locking means for engaging said post so that said post cannot be removed from said socket without damaging the seal.

2. The security seal of claim 1, wherein a longitudinal axis of said opening extends along a longitudinal axis of said strap.

3. The security seal of claim 2, wherein said second end includes an identification portion.

4. The security seal of claim 3, wherein said post includes a body portion and a head portion having a diameter larger than a diameter of said body portion, and wherein said locking means includes a deformable member disposed within said socket so that when said head portion of said post passes through said socket opening, said head portion deflects said deformable member from an original position and said body portion of said post prevents said deformable member from returning to the original position so that said post cannot be removed said socket without damaging the seal.

5. The security seal of claim 4, wherein said post is disposed on a first tab extending perpendicularly from the longitudinal axis of said strap, and wherein said socket is disposed on a second tab extending perpendicularly from the longitudinal axis of said strap in a direction opposite said first tab.

6. The security seal of claim 5, wherein the seal is a unity structure.

7. The security seal of claim 4, wherein said post and said socket are disposed on a tab extending perpendicularly from the longitudinal axis of said strap.

8. The security seal of claim 7, wherein said tab includes an upper portion adjacent said strap and on which said socket is disposed, a lower portion opposite said upper end and on which said post is disposed, and a middle portion disposed between said upper and lower portions, said middle portion being thinner than said upper and lower portions.

9. The security seal of claim 8, wherein the seal is a unity structure.

10. The security seal of claim 4, wherein said post and said socket are disposed on a tab attached to said strap, said tab extending parallel to the longitudinal axis of said strap.

11. The security seal of claim 7, wherein said tab includes a first portion adjacent said first end of said strap and on which said socket is disposed, a second end opposite said first portion and on which said post is disposed, and a middle portion disposed between said first and second portions.

12. The security seal of claim 11, wherein the seal is a unity structure.

13. The security seal of claim 4, wherein said deformable member includes deformable teeth.
